(19) United States
(12) Patent Application Publication
(10) Pub. No.: US 2023/0052552 A1
(43) Pub. Date: Feb. 16, 2023

(54) COPOLYETHERESTER RESIN COMPOSITION

(71) Applicant: DUPONT POLYMERS, INC., Wilmington, DE (US)

(72) Inventor: Petros Dafniotis, Meyrin (CH)

(21) Appl. No.: 17/786,577

(22) PCT Filed: Dec. 21, 2020
(86) PCT No.: PCT/US2020/066301

§ 371 Date: Jun. 17, 2022

Related U.S. Application Data
(60) Provisional application No. 62/954,190, filed on Dec. 27, 2019.

(51) Int. Cl. C08G 63/183; C08G 65/20; C08K 5/098; C08F 114/26

(52) U.S. Cl. CPC C08G 63/183; C08G 65/20; C08K 5/098; C08F 114/26

(57) ABSTRACT

Provided herein is a copolyetherester resin composition that is suitable for the manufacture of CVJ boots showing reduced squeak. Further provided are CVJ boots comprising the copolyetherester resin composition.

### CROSS-REFERENCE TO RELATED APPLICATION

This application claims priority under 35 U.S.C. § 365 to U.S. Provisional Application No. 62/954,190, filed on Dec. 27, 2019, which is incorporated herein by reference in its entirety.

### FIELD OF THE INVENTION

The present invention relates to the field of copolyetherester resin compositions, particularly copolyetherester compositions for reduced-squeak constant-velocity joint (CVJ) boots.

### BACKGROUND OF THE INVENTION

Several patents and publications are cited in this description in order to more fully describe the state of the art to which this invention pertains. The entire disclosure of each of these patents and publications is incorporated by reference herein.

Constant-velocity joints (also known as homokinetic or CV joints) allow a drive shaft to transmit power through a variable angle, at constant rotational speed, without an appreciable increase in friction or play. They are mainly used in front wheel drive vehicles, and many modern rear wheel drive cars with independent rear suspension typically use CV joints at the ends of the rear axle halfshafts and increasingly use them on the drive shafts.

Constant-velocity joints are protected by a rubber boot, or CVJ boot, usually filled with molybdenum disulfide grease. The CVJ boot is a ribbed, elastomeric flexible boot that keeps water and dirt out of the joint and the special grease inside the joint. Clamps are used to secure the boot to the axle and the joint and prevent grease from leaking out.

CVJ boots are typically made from thermoplastic elastomer, in particular copolyetheresters. Copolyetheresters have the desired mechanical and physical properties, good chemical resistance to grease, and permit the use of blow moulding to manufacture the CVJ boot.

A common problem in outboard CVJ boots is that under high angle between the driveshaft and the joint (typically ≥40°, α in FIG. 1), low rotation speeds (typically ≤200 rpm), and in a wet environment, the boots can emit a high frequency sound (referred to as “squeak”) often at such a high pitch that it creates discomfort for both the car occupants as well as pedestrians. This is a well-known problem for the past 20 years or more but has become even more pronounced as a result of recent developments:
A lot of attention and progress has focused on NVH (Noise Vibration Harshness) issues in vehicles by almost all manufacturers hence car interiors are quieter, making the squeak more noticeable;
Car engines have become increasingly quiet;
Electric vehicles and Hybrid vehicles at low rotation speeds are very quiet, hence the squeak is more noticeable;
CVJ boots become thinner, hence there is less noise absorption possible;
Consumers are asking for faster maneuvering in parking zones, hence the requirements for larger angles of rotation are ever increasing.

To combat this squeak noise generation, thermoplastic elastomeric resin producers have added one or more waxes to their formulations. For example. International Application WO 2018/019614 A1 discloses the use of slow and fast diffusing waxes to counter this problem.

There is a need for elastomeric resin formulations for the manufacture of CVJ boots that decrease squeak.

### SUMMARY OF THE INVENTION

In a first aspect, provided herein is a copolyetherester composition comprising:

(1) at least one copolyetherester resin; and
(2) a stearate selected from:

(2b) stearic acid at 0.3-1.0 wt %;

(2c) aluminium tristearate;

(2d) aluminium distearate;

(2e) mixtures of aluminium tristearate and aluminium distearate; and

(2f) mixtures of two or more of any of the foregoing with stearic acid or sodium stearate.

In a second aspect, provided herein is a CVJ boot made from a copolyetherester composition that comprises:

(1) at least one copolyetherester resin; and
(2) a stearate selected from:

(2b) stearic acid;

(2c) aluminium tristearate;

(2d) aluminium distearate;

(2e) mixtures of aluminium tristearate and aluminium distearate; and

(2f) mixtures of two or more of any of the foregoing with stearic acid or sodium stearate.

In a third aspect, provided herein is a copolyetherester composition comprising:

(1) at least one copolyetherester resin;
(2) a stearate selected from:

(2a) sodium stearate;

(2b) stearic acid;

(2c) aluminium tristearate;

(2d) aluminium distearate;

(2e) mixtures of aluminium tristearate and aluminium distearate; and

(2f) mixtures of two or more of any of the foregoing with sodium stearate; and

(3) polytetrafluoroethylene.

In a fourth aspect, provided herein is a CVJ boot made from a copolyetherester composition that comprises:

(1) at least one copolyetherester resin; and
(2) a stearate selected from:

(2a) sodium stearate;

(2b) stearic acid;

(2c) aluminium tristearate;

(2d) aluminium distearate;

(2e) mixtures of aluminium tristearate and aluminium distearate; and

(2f) mixtures of two or more of any of the foregoing with sodium stearate; and

(3) polytetrafluoroethylene.

### BRIEF DESCRIPTION OF THE DRAWINGS

FIG. 1 shows a schematic view in partial cross-section of a CV joint and its connection to the drive shaft. The angle α is the angle at which the rotation of the joint occurs during testing of the CVJ boot.

FIG. 2 shows a schematic axial cross-section of a CVJ boot. H designates the height, D the largest diameter, d the smallest diameter, t the wall thickness, and P the pitch (axial distance between peaks).

FIG. 3 is a graph of noise level versus time measurements obtained for a typical CVJ boot of the prior art that was subjected to squeak testing.

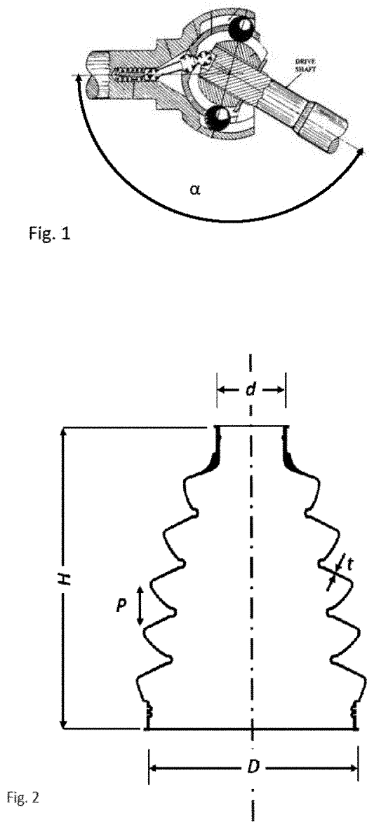

### DETAILED DESCRIPTION OF THE INVENTION

The inventors have surprisingly found that when a copolyetherester formulated with a stearate selected from: stearic acid, aluminium tristearate, aluminium distearate, mixtures of aluminium tristearate and aluminium distearate, and mixtures of any of the foregoing with stearic acid or sodium stearate is used to make CVJ boots, the resulting boots show excellent reduced-squeak performance. Squeak performance is further enhanced when PTFE is added to the compositions.

### Definitions and Abbreviations

PBT poly(butylene terephthalate)
PET poly(ethylene terephthalate)
PPT poly(propylene terephthalate)
PTFE polytetrafluoroethylene
PTMEG poly(tetramethylene oxide) glycol

Molecular weights of polymers as reported herein are reported in Daltons (Da) as number or weight average molecular weights, as determined by size exclusion chromatography (SEC).

### Copolyetherester

The one or more copolyetheresters suitable for use in the compositions described herein are preferably present in an amount from at or about 80 to at or about 96 weight percent, the weight percentage being based on the total weight of the composition. The weight percentages are complementary, that is, the sum of the weight percentages of all the components in the compositions described herein is 100 wt %.

Copolyetheresters used in the composition of the present invention have a multiplicity of recurring long-chain ester units and short-chain ester units joined head-to-tail through ester linkages, said long-chain ester units being represented by formula (A):

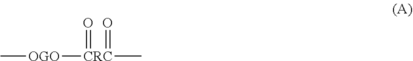

and said short-chain ester units being represented by formula (B):

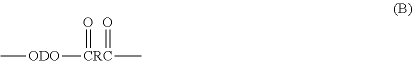

wherein
G is a divalent radical remaining after the removal of terminal hydroxyl groups from poly(alkylene oxide)glycols having a number average molecular weight of between about 400 and about 6000, or preferably between about 400 and about 3000;
R is a divalent radical remaining after removal of carboxyl groups from a dicarboxylic acid having a molecular weight of less than about 300;
D is a divalent radical remaining after removal of hydroxyl groups from a diol having a molecular weight less than about 250.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

As used herein, the term “short-chain ester units” as applied to units in a polymer chain of the copolyetheresters refers to low molecular weight compounds or polymer chain units having molecular weights less than about 550. They are made by reacting a low molecular weight diol or a mixture of diols (molecular weight below about 250) with a dicarboxylic acid to form ester units represented by Formula (B) above.

Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. Especially preferred diols are aliphatic diols containing 2-8 carbon atoms, and a more preferred diol is 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, any molecular weight requirements refer to the corresponding diols, not their derivatives.

Dicarboxylic acids that can react with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes functional equivalents of dicarboxylic acids that have two carboxyl functional groups that perform substantially like dicarboxylic acids in reaction with glycols and diols in forming copolyetherester polymers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are included provided the corresponding acid has a molecular weight below about 300. The dicarboxylic acids can contain any substituent groups or combinations that do not substantially interfere with copolyetherester polymer formation and use of the copolyetherester polymer in the compositions of the invention.

As used herein, the term “aliphatic dicarboxylic acids” refers to carboxylic acids having two carboxyl groups each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

As used herein, the term “aromatic dicarboxylic acids” refer to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative useful aliphatic and cycloaliphatic acids that can be used include sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl) carboxylic acid; and 3,4-furan dicarboxylic acid. Preferred acids are cyclohexane dicarboxylic acids and adipic acid.

Representative aromatic dicarboxylic acids include phthalic, terephthalic and isophthalic acids; bibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C1-C12 alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used.

Aromatic dicarboxylic acids are a preferred class for preparing the copolyetherester elastomers useful for this invention. Among the aromatic acids, those with 8-16 carbon atoms are preferred, particularly terephthalic acid alone or with a mixture of phthalic and/or isophthalic acids. The copolyetherester elastomer preferably comprises from at or about 15 to at or about 99 weight percent short-chain ester units corresponding to Formula (B) above, the remainder being long-chain ester units corresponding to Formula (A) above. More preferably, the copolyetherester elastomers comprise from at or about 20 to at or about 95 weight percent, and even more preferably from at or about 50 to at or about 90 weight percent short-chain ester units, where the remainder is long-chain ester units. More preferably, at least about 70% of the groups represented by R in Formulae (A) and (B) above are 1,4-phenylene radicals and at least about 70% of the groups represented by D in Formula (B) above are 1,4-butylene radicals and the sum of the percentages of R groups which are not 1,4-phenylene radicals and D groups that are not 1,4-butylene radicals does not exceed 30%. If a second dicarboxylic acid is used to prepare the copolyetherester, isophthalic acid is preferred and if a second low molecular weight diol is used, ethylene glycol, 1,3-propanediol, cyclohexanedimethanol, or hexamethylene glycol are preferred. When used in connection with copolyetheresters, the weight percentages of the copolymerized residues, such as long- and short-chain esters, aliphatic radicals, and dicarboxylic acids, are based on the total weight of the copolyetherester. Moreover, the weight percentages are complementary, that is, the sum of the weight percentages of all the copolymerized units in the copolyetheresters is 100 wt %.

A blend or mixture of two or more copolyetherester elastomers can be used. The copolyetherester elastomers used in the blend need not on an individual basis come within the values disclosed hereinbefore for the elastomers. However, the blend of two or more copolyetherester elastomers must conform to the values described herein for the copolyetheresters on a weighted average basis. For example, in a mixture that contains equal amounts of two copolyetherester elastomers, one copolyetherester elastomer can contain 60 weight percent short-chain ester units and the other resin can contain 30 weight percent short-chain ester units for a weighted average of 45 weight percent short-chain ester units.

Preferred copolyetherester elastomers are those prepared from the monomers (1) a poly(alkylene oxide)diol, (2) a dicarboxylic acid selected from terephthalate, isophthalate and mixtures thereof, (3) a diol selected from butane diol, propane diol and mixtures thereof.

The poly(alkylene oxide)diol is referred to as the “soft segment”, and the polyester segments (e.g. PET, PPT and/or PBT) are referred to as the “hard segment”.

Preferred copolyetherester elastomers include copolyetherester elastomers prepared from monomers comprising (1) poly(tetramethylene oxide) glycol (“PTMEG”); (2) a dicarboxylic acid selected from isophthalic acid, terephthalic acid and mixtures thereof; and (3) a diol selected from 1,4-butanediol, 1,3-propanediol and mixtures thereof, or from monomers comprising (1) poly(trimethylene oxide) glycol; (2) a dicarboxylic acid selected from isophthalic acid, terephthalic acid and mixtures thereof; and (3) a diol selected from 1,4-butanediol, 1,3-propanediol and mixtures thereof, or from monomers comprising (1) ethylene oxide-capped poly(propylene oxide) glycol; (2) a dicarboxylic acid selected from isophthalic acid, terephthalic acid and mixtures thereof; and (3) a diol selected from 1,4-butanediol, 1,3-propanediol and mixtures thereof.

Preferably, the copolyetherester elastomers described herein are prepared from esters or mixtures of esters of terephthalic acid and/or isophthalic acid, 1,4-butanediol and poly(tetramethylene ether)glycol or poly(trimethylene ether) glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetheresters are prepared from esters of terephthalic acid, e.g., dimethylterephthalate, 1,4-butanediol and poly(tetramethylene ether)glycol.

In a preferred embodiment, the compositions according to the present invention comprise copolyetherester elastomers prepared from monomers comprising (1) poly(tetramethylene oxide) glycol or poly(trimethylene oxide) glycol and mixtures thereof; (2) a dicarboxylic acid selected from the group consisting of isophthalic acid, terephthalic acid and mixtures thereof; and (3) a diol selected from the group consisting of 1,4-butanediol, 1,3-propanediol and mixtures thereof.

More preferably, the compositions according to the present invention comprise copolyetherester elastomers prepared from monomers comprising (1) poly(tetramethylene oxide) glycol; (2) terephthalic acid; and (3) 1,4-butanediol.

The content of soft segment in the copolyetherester is preferably from 30 wt % to 55 wt %, more preferably from 35 wt % to 50 wt %, particularly preferably from 40 wt % to 50 wt %, even more particularly preferably 44 wt % and 45 wt %, based on the total weight of the copolyetherester.

Particularly preferred copolyetheresters have the soft segment poly(tetramethylene oxide) glycol at between 30 wt % and 55 wt %, more preferably between 35 wt % and 50 wt %, particularly preferably between 40 wt % and 50 wt %, even more particularly preferably 44 wt % and 45 wt %, based on the total weight of the copolyetherester.

The copolyetheresters preferably have a number average molecular weight of between 35,000 and 100,000, more particulardy preferably between 40,000 and 75,000.

Particularly preferred are copolyetheresters prepared from the monomers terephthalate, poly(tetramethylene oxide) glycol and butane diol. Even more preferred are such copolyetheresters having 35-55 wt % poly(tetramethylene oxide), the remainder being poly(butylene terephthalate) (“PBT”) segments.

A particularly preferred copolyetherester is one prepared from the monomers terephthalate, poly(tetramethylene oxide) glycol and butane diol, having 42-48 wt % poly(tetramethylene oxide), the remainder being poly(butylene terephthalate) (“PBT”) segments.

### Stearate

The compositions of the invention comprise a stearate selected from stearic acid (at 0.3 to 1 wt %), aluminium tristearate, aluminium distearate, mixtures of aluminium tristearate and aluminium distearate, and mixtures of any of the foregoing with stearic acid or sodium stearate. When the compositions of the invention comprise PTFE, the stearate may also be sodium stearate.

When present in the composition, the amount of stearic acid is about 0.3 to 1 wt %, based on the total weight of the composition. The total concentration of all other stearates in the composition is preferably from 0.2 to 2 wt %, more preferably 0.4 to 1.5 wt %, based on the total weight of the composition. The “total concentration of all other stearates” refers to the sum of the concentrations of the stearates in the composition, less the concentration of stearic acid. Stated alternatively, with the exception of stearic acid, which is used at 0.3 to 1 wt %, the total stearate concentration in the composition is preferably from 0.2 to 2 wt %, more preferably 0.4 to 1.5 wt %, based on the total weight of the composition.

Preferred stearates are selected from the following, in descending order of preference by squeak performance:

(1) aluminium tristearate plus sodium stearate;
(2) aluminium distearate;
(3) stearic acid; and
(4) aluminium distearate plus sodium stearate or aluminium distearate plus stearic acid.

Particularly preferred stearates are selected from the following (weight percentages are based on the total weight of the composition):

(1) aluminium tristearate at 0.5 to 1 wt %, plus sodium stearate at 0.25 to 0.75 wt %;
(2) aluminium distearate at 0.5 to 1 wt %;
(3) stearic acid at 0.3 to 0.8 wt %; and
(4) aluminium distearate at 0.5 to 1 wt % plus sodium stearate at 0.25 to 0.75 wt %, or aluminium distearate at 0.5 to 1 wt % plus stearic acid at 0.25 to 0.75 wt %.

More particularly preferred stearates are selected from the following (weight percentages are based on the total weight of the composition):

(1) aluminium tristearate at 0.8 wt %, plus sodium stearate at 0.5 wt %;
(2) aluminium distearate at 0.8 wt %;
(3) stearic acid at 0.7 wt %; and
(4) aluminium distearate at 0.6 wt % plus sodium stearate at 0.5 wt %, or aluminium distearate at 0.6 wt % plus stearic acid at 0.5 wt %.

### Polytetrafluoroethylene

Preferred compositions of the invention comprise PTFE. Suitable PTFE's have a molecular weight of greater than 10⁸ Da. Preferred PTFE's have molecular weights in the range of 10⁶-10⁸ Da, with 10⁸ Da being particularly preferred.

The PTFE is preferably added to the copolyetherester in the melt in the form of:
Aqueous dispersions of PTFE, preferably PTFE having a molecular weight in the range of 10⁶-10⁸ Da, more preferably 10⁸ Da;
Encapsulated PTFE, for example PTFE encapsulated with an acrylate polymer, such a poly(methyl methacrylate), preferably PTFE having a molecular weight in the range of 10⁶-10⁸ Da, more preferably 10⁸ Da.

PTFE is preferably added to the compositions of the invention to yield a final concentration of PTFE, based on the total weight of the composition, of from 0.05 to 0.5 wt %, more preferably 0.1 to 0.3 wt %, particularly preferably 0.1 or 0.2 wt %.

For compositions of the invention containing PTFE, preferred combinations with stearates, in descending order of preference by squeak performance, are the following:

(1) PTFE plus aluminium distearate;
(2) PTFE plus aluminium tristearate;
(3) PTFE plus aluminium distearate plus stearic acid;
(4) PTFE plus aluminium distearate plus sodium stearate;
(5) PTFE plus aluminium tristearate plus sodium stearate;
(6) PTFE plus sodium stearate.

Particularly preferred are:

(1) PTFE plus aluminium distearate at 0.5 to 1.5 wt %, more preferably 1 wt %;
(2) PTFE plus aluminium tristearate at 0.5 to 1.5 wt %, more preferably 1 wt %;
(3) PTFE plus aluminium distearate at 0.4 to 1 wt %, more preferably 0.6 wt % plus stearic acid at 0.3 to 1 wt %, more preferably 0.5 wt %;
(4) PTFE plus aluminium distearate at 0.5 to 1 wt %, preferably 0.6 wt % plus sodium stearate at 0.4 to 1 wt %, preferably 0.8 wt %; and
(5) PTFE plus aluminium tristearate at 0.3 to 1 wt %, preferably 0.5 wt % plus sodium stearate at 0.3 to 1 wt %, preferably 0.5 wt %; and
(6) PTFE plus sodium stearate at 0.2 to 0.8 wt %.

Waxes

The compositions of the invention may also comprise traditional waxes. Such waxes are relatively low molecular weight molecules (MW between 300 and 3000 Da, most preferably around 500 Da). These waxes are typically added at concentrations of from 0.01 to 5%, usually less than 1 wt %. The families of “traditional” waxes typically used in CVJ boots are:

1. Compounds with unsaturated fatty acids, such as unsaturated amides, e.g. ethylene bis-oleamide, erucamide

2. Compounds with saturated fatty acids such as saturated amides, e.g. ethylene bis-stearamide, ethylene bis-capramide, etc.

3. Polyethylene based non-polar waxes, e.g. Licowax™ PES20, available commercially from Clariant AG of Muttenz, Switzerland (“Clariant”)

4. Esters of montanic acid, e.g. Licolub™ WE40, available commercially from Clariant

5. Glycols, e.g. PTMEG with molecular weights between 800 and 3,000 Da, particularly PTMEG with a molecular weight of 2,000 Da.

### Additional Ingredients

The copolyetherester compositions described herein may further comprise additives that include, but are not limited to, one or more of the following components as well as combinations of these: metal deactivators, such as hydrazine and hydrazide; heat stabilizers; antioxidants; modifiers; colorants, lubricants, fillers and reinforcing agents, impact modifiers, flow enhancing additives, antistatic agents, crystallization promoting agents, conductive additives, viscosity modifiers, nucleating agents, plasticizers, mold release agents, scratch and mar modifiers, drip suppressants, adhesion modifiers and other processing aids known in the polymer compounding art. Preferably, the additives are selected from the group consisting of stabilizers, processing agents, metal deactivators, antioxidants, UV stabilizers, heat stabilizers, dyes and/or pigments. When used, additional additives are preferably present in amounts of about 0.05 to about 10 weight percent, based on the total weight of the copolyetherester composition.

The copolyetherester compositions described herein are melt-mixed blends, wherein all of the polymeric components are dissolved or well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention.

The polymeric components and non-polymeric ingredients of the copolyetherester compositions of the invention may be added to a melt mixer, such as, for example, a single or twin-screw extruder; a blender; a single or twin-screw kneader; or a Banbury mixer, either simultaneously through a single step addition, or in a stepwise fashion, and then melt-mixed. When adding the polymeric components and non-polymeric ingredients in a stepwise fashion, a portion of the polymeric components and/or non-polymeric ingredients are first added and melt-mixed with the remaining polymeric components and non-polymeric ingredients being subsequently added and further melt-mixed until a well-mixed composition is obtained.

Preferred Compositions

Preferred combinations comprise the following ingredients, with weight percentages being based on the total weight of the composition:

(1) at least one copolyetherester;
(2) aluminium distearate, preferably at 0.5 to 1.2 wt %, more preferably 0.8 wt %.
(1) at least one copolyetherester;
(2) aluminium tristearate plus sodium stearate, preferably 0.5 to 1.2 wt %, more preferably 0.8 wt % aluminium tristearate plus 0.2 to 0.7 wt % sodium stearate.
(1) at least one copolyetherester;
(2) aluminium distearate plus stearic acid, preferably 0.5 to 1.2 wt %, more preferably 0.6 wt % aluminium distearate plus 0.4 to 0.7 wt % stearic acid.
(1) at least one copolyetherester;
(2) a stearate selected from:
(a) aluminium distearate;
(b) aluminium tristearate;
(c) aluminium distearate plus stearic acid;
(d) aluminium distearate plus sodium stearate;
(e) aluminium tristearate plus sodium stearate; and
(f) sodium stearate.

### (3) PTFE

(1) at least one copolyetherester;
(2) aluminium distearate;

### (3) PTFE

(1) at least one copolyetherester;
(2) aluminium tristearate;

### (3) PTFE

(1) at least one copolyetherester;
(2) aluminium distearate plus stearic acid;

### (3) PTFE

(1) at least one copolyetherester:
(2) aluminium distearate plus sodium stearate;

### (3) PTFE

(1) at least one copolyetherester:
(2) aluminium tristearate plus sodium stearate;

### (3) PTFE

(1) at least one copolyetherester;
(2) sodium stearate;

### (3) PTFE

(1) at least one copolyetherester;
(2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.05 to 0.5 wt %, more preferably 0.1 to 0.3 wt %, particularly preferably 0.1 or 0.2 wt %.
   (1) at least one copolyetherester;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester;
   (2) aluminium tristearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester;
   (2) aluminium distearate plus stearic acid, preferably aluminium distearate at 0.5 to 1.2 wt %, more preferably 0.8 to 1 wt %, and stearic acid at 0.25 to 1 wt %, more preferably 0.3 to 0.7 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) a stearate selected from:
(2b) stearic acid at 0.3-1.0 wt %;
(2c) aluminium tristearate;
(2d) aluminium distearate;
(2e) mixtures of aluminium tristearate and aluminium distearate; and
(2f) mixtures of any of the foregoing with stearic acid or sodium stearate.
   (1) at least one copolyetherester made from PTMEG, terephthalate and 1,4-butane diol;
   (2) aluminium distearate, preferably at 0.5 to 1.2 wt %, more preferably 0.8 wt %.
   (1) at least one copolyetherester made from PTMEG, terephthalate and 1,4-butane diol;
   (2) aluminium tristearate plus sodium stearate, preferably 0.5 to 1.2 wt %, more preferably 0.8 wt % aluminium tristearate plus 0.2 to 0.7 wt % sodium stearate.
   (1) at least one copolyetherester made from PTMEG, terephthalate and 1,4-butane diol;
   (2) aluminium distearate plus stearic acid, preferably 0.5 to 1.2 wt %, more preferably 0.6 wt % aluminium distearate plus 0.4 to 0.7 wt % stearic acid.
   (1) at least one copolyetherester made from PTMEG, terephthalate and 1,4-butane diol;
   (2) a stearate selected from:
(2a) sodium stearate;
(2b) stearic acid;
(2c) aluminium tristearate;
(2d) aluminium distearate;
(2e) mixtures of aluminium tristearate and aluminium distearate; and
(2f) mixtures of any of the foregoing with sodium stearate; and
   (3) polytetrafluoroethylene.
   (1) at least one copolyetherester made from PTMEG, terephthalate and 1,4-butane diol;
   (2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) aluminium tristearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) aluminium distearate plus stearic acid, preferably aluminium distearate at 0.5 to 1.2 wt %, more preferably 0.8 to 1 wt %, and stearic acid at 0.25 to 1 wt %, more preferably 0.3 to 0.7 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, preferably at 0.5 to 1.2 wt %, more preferably 0.8 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium tristearate plus sodium stearate, preferably 0.5 to 1.2 wt %, more preferably 0.8 wt % aluminium tristearate plus 0.2 to 0.7 wt % sodium stearate.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate plus stearic acid, preferably 0.5 to 1.2 wt %, more preferably 0.6 wt % aluminium distearate plus 0.4 to 0.7 wt % stearic acid.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium tristearate, preferably at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate plus stearic acid, preferably aluminium distearate at 0.5 to 1.2 wt %, more preferably 0.8 to 1 wt %, and stearic acid at 0.25 to 1 wt %, more preferably 0.3 to 0.7 wt %;
   (3) PTFE at 0.05 to 0.5 wt %, more preferably 0.1 to 0.3 wt %, particularly preferably 0.1 or 0.2 wt %.
   (1) at least one copolyetherester;
   (2) aluminium distearate at 0.5 to 1.2 wt %, more preferably 0.8 wt %.
   (1) at least one copolyetherester;
   (2) aluminium tristearate plus sodium stearate, at 0.5 to 1.2 wt %, more preferably 0.8 wt % aluminium tristearate plus 0.2 to 0.7 wt % sodium stearate.
   (1) at least one copolyetherester;
   (2) aluminium distearate plus stearic acid, at 0.5 to 1.2 wt %, more preferably 0.6 wt % aluminium distearate plus 0.4 to 0.7 wt % stearic acid.
   (1) at least one copolyetherester;
   (2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.1 to 0.3 wt %, particularly preferably 0.1 or 0.2 wt %.
   (1) at least one copolyetherester;
   (2) aluminium distearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester;
   (2) aluminium distearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester:
   (2) aluminium tristearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester;
   (2) aluminium distearate plus stearic acid, with aluminium distearate at 0.8 to 1 wt %, and stearic acid at 0.3 to 0.7 wt %;
   (3) PTFE at 0.1 to 0.3 wt %, particularly preferably 0.1 or 0.2 wt %.
   (1) at least one copolyetherester made from PTMEG, terephthalate and 1,4-butane diol;
   (2) aluminium distearate, at 0.5 to 1.2 wt %, more preferably 0.8 wt %.
   (1) at least one copolyetherester made from PTMEG, terephthalate and 1,4-butane diol;
   (2) aluminium tristearate plus sodium stearate, at 0.5 to 1.2 wt %, more preferably 0.8 wt % aluminium tristearate plus 0.2 to 0.7 wt % sodium stearate.
   (1) at least one copolyetherester made from PTMEG, terephthalate and 1,4-butane diol;
   (2) aluminium distearate plus stearic acid, at 0.5 to 1.2 wt %, more preferably 0.6 wt % aluminium distearate plus 0.4 to 0.7 wt % stearic acid.
   (1) at least one copolyetherester made from PTMEG, terephthalate and 1,4-butane diol;
   (2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.1 to 0.3 wt %, particularly preferably 0.1 or 0.2 wt %.
   (1) at least one copolyetherester made from PTMEG, terephthalate and 1,4-butane diol;
   (2) aluminium distearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester made from PTMEG, terephthalate and 1,4-butane diol;
   (2) aluminium distearate, at 0.5 to 1.2 wt %, more preferably 0.8 to 1 wt %;
   (3) PTFE at 0.05 to 0.5 wt %, more preferably 0.1 to 0.3 wt %, particularly preferably 0.1 or 0.2 wt %.
   (1) at least one copolyetherester made from PTMEG, terephthalate and 1,4-butane diol;
   (2) aluminium tristearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester made from PTMEG, terephthalate and 1,4-butane diol;
   (2) aluminium distearate plus stearic acid, aluminium distearate at 0.5 to 1.2 wt %, more preferably 0.8 to 1 wt %, and stearic acid at 0.25 to 1 wt %, more preferably 0.3 to 0.7 wt %;
   (3) PTFE at 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, at 0.5 to 1.2 wt %, more preferably 0.8 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium tristearate plus sodium stearate, at 0.5 to 1.2 wt %, more preferably 0.8 wt % aluminium tristearate plus 0.2 to 0.7 wt % sodium stearate.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate plus stearic acid, at 0.5 to 1.2 wt %, more preferably 0.6 wt % aluminium distearate plus 0.4 to 0.7 wt % stearic acid.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) a stearate selected from:
stearic acid;
aluminium tristearate;
aluminium distearate;
mixtures of aluminium tristearate and aluminium distearate; and
mixtures of any of the foregoing with stearic acid or sodium stearate;
   (3) PTFE at 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium tristearate, at 0.5 to 1.2 wt %, more preferably 0.8 to 1 wt %;
   (3) PTFE at 0.1 to 0.3 wt %, particularly preferably 0.1 or 0.2 wt %.
   (1) at least one copolyetherester made from PTMEG, terephthalate and 1,4-butane diol, having a soft segment content of from 40 wt % to 50 wt %, more preferably 44 wt % and 45 wt %, based on the total weight of the copolyetherester;
   (2) aluminium distearate plus stearic acid, aluminium distearate at 0.5 to 1.2 wt %, more preferably 0.8 to 1 wt %, and stearic acid at 0.25 to 1 wt %, more preferably 0.3 to 0.7 wt %;
   (3) PTFE at 0.1 to 0.3 wt %, particularly preferably 0.1 or 0.2 wt %.

### CVJ Boot

The invention provides a CVJ boot made with a composition of the invention.

Referring to FIG. 2, which shows an axial cross section of a typical CVJ boot, the boot is generally of hollow truncated conical shape having height “H”, a smaller diameter “d” at one end which fits around the axel, and a larger diameter “D” at the other end which is attached to the joint. It has bellows, defined by peaks and troughs, with a distance between peaks, called the pitch and designated “P”. The wall thickness is designated “t”.

A CVJ boot of the invention is made with any one of the copolyetherester compositions of the invention and has any shape or conformation that is suitable for a CVJ boot. In addition, a CVJ boot of the invention is made using any technology for shaping polymers. Particularly suitable are injection moulding, press blow molding, and extrusion and injection blow moulding. Particularly preferred is press blow molding.

In press blow-moulding the polymer resin is extruded into a cavity where a piston pushes material up, thereby creating a parison. The parison is lifted up into a mold and then air is blown to get the final product.

A typical CVJ boot for use in a passenger car has a weight around 40-80 grams.

The dimensions of the CVJ boot are chosen for the size and dimensions of the vehicle. Some typical dimensions for use in a passenger car are the following:

### Height 60 to 120 mm;

### Pitch: 9 to 18 mm;

Number of bellows: 5 to 7;
Wall thickness t: 0.9 to 1.3 mm;
Max. Diameter D: 100 mm;
Min. Diameter d: 25 mm

### Height=114.6 mm

Min. diameter d: 29.4 mm
Max. diameter D: 85.1 mm

### Pitch: 17.4 mm

Wall thickness average t: 1.5 mm

### Weight=59.63 g

In a particularly preferred embodiment, the CVJ boot has 7 bellows, thickness ˜1.1 mm, height 115-120 mm, weight ˜75 g.

### Squeak Performance

CVJ boots made with the copolyetherester compositions of the invention show decreased squeak as compared to conventional CVJ boots.

Squeak performance is evaluated as follows:

A squeak testing rig is used that allows a defined rotational speed and angle to be applied. Squeak performance is typically evaluated at an angle of 40° between the driveshaft and the joint and a rotational speed of <200 rpm.

The boot and the joint are filled with grease, for example a grease based on mineral oil and having paraffinic mineral type oil (75-85 wt %), polyurea type thickener (˜5-15 wt %), as well as the usual set of grease modifiers for friction [typically molybdenum disulfide (MoS₂), or molybdenum dibutyldithiocarbamate (MoDTC)], rust protection, abrasion inhibitor (typically zinc dithiophosphate—ZnDTP) and antioxidant. Grease is applied as ˜70 g in the joint and ˜50 g in the boot interior surface.

The squeak performance of the boots is evaluated while wet by spraying the boots while in the testing rig. The amount of water spray is typically kept between 10 and 20 g per min. Water pressure is kept <1 bar, to avoid excessive surface destruction and buildup of bubbles from the atomizing air. Water is sprayed at a wide angle to cover all the boot surface to better simulate driving conditions.

The system is allowed an initial warm up of ten minutes at 150 rpm. Then the following cycles are applied:

1. Rotational speed of 70 rpm. Experimental protocol: cycle of 20 seconds
a) 10 s spray of water (4.5 ml)
b) 10 s just rotation (no spraying)

This yields a discharge of water at a rate of ˜13 ml/min

2. Rotational speed of 150 rpm. Experimental protocol: cycle of 100 seconds:
a) 30 s spray of water (30 ml)
b) 70 s just rotation (no spraying)

This yields a discharge of water at a rate of ˜18 ml/min

3. Rotational speed of 70 rpm. Experimental protocol: continuous spray of water (10 ml/min).

Tap water is employed as source for water, the temperature of water should be between 16 and 22° C.

After 60 seconds of rotating the CVJ boot, the noise is measured using a microphone (National Instruments GRAS ½″ Free-Field Response Microphone) placed 18 cm from the boot, pointed directly at the boot bellows, and is converted to dB(A), time averaged over one boot rotation (e.g. at 150 rpm, this is 0.4 seconds). “dB(A)” refers to A-weighting of dB.

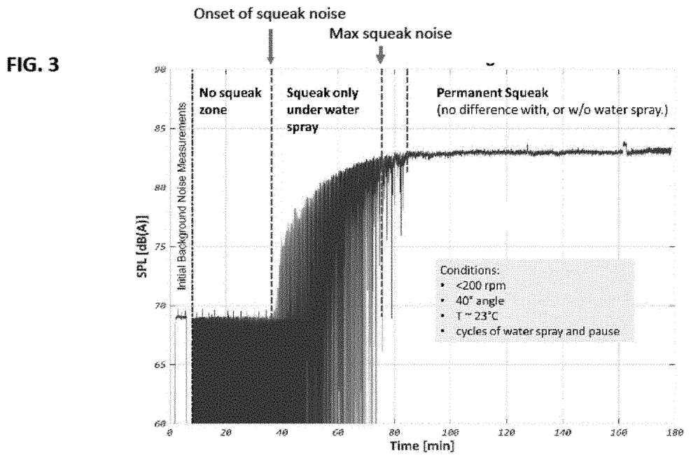

Plotting noise over time, one sees a surface bounded by an upper and a lower curve. The upper curve, called the “spray curve” is initially dominated by the noise of the atomized water spray; the bottom curve, called the “pause curve” is initially the background noise. The curve reflects three events that are seen in each experiment, and that are visible in the graph of FIG. 3:

1. Onset of squeak noise: the point where the spray curve passes from an initial flat response (representing noise from the atomizing spray) to a significant positive slope for more than 12 cycles (3 min) from the initial flat part.
2. Reaching max squeak noise: the point where the spray curve reaches roughly its maximum
3. Reaching permanent squeak noise: the point where the spray and pause curves become virtually indistinguishable.

Squeak performance is reported as time to initial squeak and time to max squeak. The greater the value of these intervals, the better the anti-squeak performance.

CVJ boots made with copolyetherester compositions of the invention have a time to initial squeak of 1,000 minutes or greater, preferably 2,000 minutes or greater, more preferably 4,000 minutes or greater, particularly preferably 10,000 minutes or greater. CVJ boots made with copolyetherester compositions of the invention have a time to max squeak of 1,000 minutes or greater, preferably 2,000 minutes or greater, more preferably 4,000 minutes or greater, particularly preferably 10,000 minutes or greater.

The following examples are provided to describe the invention in further detail. These examples, which set forth a preferred mode presently contemplated for carrying out the invention, are intended to illustrate and not to limit the invention.

### EXAMPLES

Resin Formulations

Resin formulations were compounded by melt blending a salt-and-pepper blend of the components in a twin-screw extruder. The compounded melt blended mixtures of comparative examples and of all examples were extruded in the form of laces or strands, cooled in a water bath, chopped into granules and placed in sealed aluminum lined bags in order to prevent moisture pick-up.

The copolyetheresters used had PBT hard segments and polytetramethylene oxide (“PTMEG”) soft segments. Specifically:

TPC-ET A: 45.3 wt % PTMEG soft segment, based on the total weight of the TPC-ET A, the remainder being hard segment made by the reaction of dimethyl-terephthalate and 1,4-butanediol.

TPC-ET B: 43.9 wt % PTMEG soft segment, based on the total weight of the TPC-ET B, the remainder being hard segment made by reaction of dimethyl-terephthalate and 1,4-butanediol. The following stearates were used:
Aluminium distearate (AldiSt)
Aluminium tistearate (AltSt)
Sodium stearate (NaSt)
Stearic acid (St)
Calcium stearate (CaSt)
Zinc stearate (ZnSt)

The following PTFE's were used:
PTFE1: PTFE high molecular weight (10⁸ Da) as an aqueous dispersion
PTFE2: high molecular weight PTFE (10⁹ Da) encapsulated in MMA (poly(methyl methacrylate)) with PTFE at 20 wt %, based on the total weight of PTFE and MMA
PTFE3: high molecular weight PTFE (10⁸ Da) encapsulated in MMA with PTFE at 50 wt %, based on the total weight of PTFE and MMA

The following waxes were used:
N,N′-ethylenebisoleamide
Erucamide
Licowax™ PE520: a low molecular weight polyethylene wax commercially available from Clariant
Licowax™ S-FL: octacosanoic acid commercially available from Clariant
PTMEG-2000: a PTMEG having an average molecular weight of 2000.

### CVJ Boots

CVJ boots were made from the various resin formulations by press blow moulding, for example, using a DSE150 pressblower machine available from OSSBERGER GmbH+Co. KG of Weissenburg in Bayem, Germany.

Results designated with an “A” in Table 1 were generated with a CVJ boot having the following dimensions:
6-7 bellows
Weight=59.63 g
Height=114.6 mm
Top diameter=29.4 mm (external)
Bottom diameter=85.1 mm (external)
Peak to Peak (below N^{o} 3 and N^{o} 4)=17.4 mm
Wall thickness average 1.5 mm
Min. diameter=26 mm
Max. diameter=81 mm
   Results designated with a “K” in Table 1 were generated with a CVJ boot having the following dimensions:
7 bellows
Wall thickness ˜1.1 mm
Height 115-120 mm
Weight ˜75 g

### Squeak Testing

A CVJ boot testing rig conforming to SAE J2028 (2000) was used.

The squeak testing rig allowed a defined rotational speed and angle to be applied. The majority of the experimental work used an angle of 40° between the driveshaft and the joint and a rotational speed of <200 rpm.

The boot and the joint were filled with grease based on mineral oil and having paraffinic mineral type oil (75-85 wt %), polyurea type thickener (˜5-15 wt %), as well as the usual set of grease modifiers for: friction [typically molybdenum disulfide (MoS₂), or molybdenum dibutyldithiocarbamate (MoDTC)], rust protection, abrasion inhibitor (typically zinc dithiophosphate—ZnDTP) and antioxidant. Grease was applied as ˜70 g in the joint and ˜50 g in the boot interior surface.

The squeak performance of the boots was evaluated while wet by spraying the boots while in the testing rig. The amount of water spray was kept between 10 and 20 g per min. Water pressure was kept <1 bar, to avoid excessive surface destruction and buildup of bubbles from the atomizing air. Water was sprayed at a wide angle to cover all the boot surface to better simulate driving conditions.

The system after an initial warm up of ten minutes at 150 rpm underwent a series of cycles as follows:

Three conditions were tested:
1. Rotational speed of 70 rpm. Experimental protocol: cycle of 20 seconds
a) 10 s spray of water (4.5 ml)
b) 10 s just rotation (no spraying)

This yields a discharge of water at a rate of ˜13 ml/min

2. Rotational speed of 150 rpm. Experimental protocol: cycle of 100 seconds:
a) 30 s spray of water (30 ml)
b) 70 s just rotation (no spraying)

This yields a discharge of water at a rate of ˜18 ml/min

3. Rotational speed of 70 rpm. Experimental protocol: continuous spray of water (10 ml/min).

In all cases, tap water was employed as source for water, the temperature of water was between 16 and 22° C.

After 60 seconds of rotating the CVJ boot, the noise was measured using a microphone (GRAS ½″ Free-Field Response Microphone, available from National Instruments of Austin, Tex.) placed 18 cm from the boot, pointed directly at the boot bellows, and was converted to dB(A), time averaged over one boot rotation (e.g. at 150 rpm, this is 0.4 seconds).

Plotting noise over time, one sees a surface bounded by an upper and a lower curve. The upper curve, called the “spray curve” is initially dominated by the noise of the atomized water spray; the bottom curve, called the “pause curve” is initially the background noise. The curve reflects three events that are seen in each experiment:

1. Onset of squeak noise: the point where the spray curve passes from an initial flat response (representing noise from the atomizing spray) to a significant positive slope for more than 12 cycles (3 min) from the initial flat part.
2. Reaching max squeak noise: the point where the spray curve reaches roughly its maximum
3. Reaching permanent squeak noise: the point where the spray and pause curves become virtually indistinguishable.

FIG. 3 shows noise level versus time for a typical CVJ boot subjected to squeak testing. The vertical axis is the Sound Pressure Level (SPL) measured in units of dB(A).

### Results

Results are reported in Table 1 as time to initial squeak and time to max squeak. Squeak is defined as high pitch noise ≥75 dB(A) (at the 18 cm distance the microphone is placed). High pitch noise is understood to be noise where the dominant frequency is ≥1 kHz. Dominant frequency is the frequency that has the relatively higher power vs other frequencies.

The results of squeak testing for the various resin formulations are listed in Table 1.

Comparative compositions are designated with a “C”, and compositions according to the invention are designated with an “E”.

CVJ boots made from copolyetherester compositions of the invention show significantly improved time to initial squeak and time to max squeak. All compositions of the invention result in CVJ boots having a time to initial squeak of 1,000 minutes or greater.

TABLE 1
Time to initial squeak and time to max squeak for CVJ boots made with compositions of the invention.

| | | | | | | | | | | | | Time | Time | |
|---|---|---|---|---|---|---|---|---|---|---|---|---|---|---|
| | | | | | | | | | | | | to | to | |
| | base | | | | PTFE | | | | | | | initial | max | Max |
| | poly- | Boot | Classic wax | | | wt % | wt % | Stearate | | 2nd Stearate | | squeak | squeak | Noise |
| Ref. | mer | type | Wax | wt % | Material | material | PTFE | Material | wt % | Material | wt % | min | Min | dB(A) |
| C0 | A | A | N,N′- | 0.2 | | | | | | | | 80 | 130 | 83 |
| | | | ETHYLENEBISOLEAMIDE | | | | | | | | | | | |
| C1 | B | A | PTMEG-2000 | 3.8 | | | | | | | | 50 | 140 | 84 |
| C2 | A | A | | | PTFE2 | 0.5 | 0.1 | | | | | 50 | 300 | 86 |
| C4 | B | A | PTMEG-2000 | 3.8 | PTFE3 | 0.5 | 0.25 | | | | | 140 | 320 | 86 |
| E8 | A | A | | | PTFE1 | 0.3 | 0.18 | NaSt | 0.5 | | | 1000 | 1800 | 87 |
| C21 | A | A | N,N′- | 0.5 | PTFE1 | 0.5 | 0.3 | | | | | 80 | 110 | 85 |
| | | | ETHYLENEBISOLEAMIDE | | | | | | | | | | | |
| C22 | A | A | Erucamide | 1 | PTFE1 | 0.5 | 0.3 | | | | | 60 | 150 | 84 |
| E31 | A | A | | | PTFE1 | 0.4 | 0.24 | NaSt | 0.5 | | | 1050 | 1100 | 81 |
| E33 | A | A | | | PTFE1/ | 0.3/1.0 | 0.38 | NaSt | 0.5 | | | 1100 | 2500 | 81 |
| | | | | | PTFE2 | | | | | | | | | |
| E34 | A | A | | | PTFE2 | 1 | 0.2 | NaSt | 0.5 | | | 1000 | 1200 | 81 |
| C35 | A | A | Erucamide | 1 | PTFE2 | 1 | 0.2 | | | | | 30 | 100 | 86 |
| C36 | B | A | PTMEG-2000 | 2 | PTFE2 | 1 | 0.2 | | | | | 30 | 100 | 87 |
| | | | Licowax PE520 | 0.5 | | | | | | | | | | |
| E42 | A | A | | | PTFE2 | 1 | 0.2 | NaSt | 0.2 | | | 2000 | 2200 | 84 |
| E43 | A | A | | | PTFE3 | 0.8 | 0.4 | NaSt | 0.2 | | | 1300 | 1400 | 86 |
| E51 | A | A | N,N′- | 0.2 | PTFE2 | 1 | 0.2 | NaSt | 0.6 | | | 3200 | 4500 | 84 |
| | | | ETHYLENEBISOLEAMIDE | | | | | | | | | | | |
| E55 | A | A | | | PTFE1/ | 0.4/1.0 | 0.44 | NaSt | 0.8 | AldiSt | 0.7 | 7800 | 8500 | 86 |
| | | | | | PTFE2 | | | | | | | | | |
| E85 | A | A | | | PTFE3 | 1 | 0.5 | NaSt | 0.5 | AltSi | 0.5 | 5500 | 7000 | 84 |
| E90 | A | A | | | PTFE2 | 1 | 0.2 | AldiSt | 1 | | | 13000 | 14000 | 77¹ |
| E91 | A | A | | | PTFE2 | 1 | 0.2 | AldiSt | 1 | | | 15000 | 16000 | 82 |
| E92 | A | A | N,N′- | 0.2 | PTFE2 | 1 | 0.2 | AldiSt | 1 | | | 10000 | 13000 | 81 |
| | | | ETHYLENEBISOLEAMIDE | | | | | | | | | | | |
| E93 | B | A | N,N′- | 0.2 | PTFE2 | 0.5 | 0.1 | AldiSt | 1 | | | 15000 | 16000 | 77¹ |
| | | | ETHYLENEBISOLEAMIDE | | | | | | | | | | | |
| E94 | B | A | N,N′- | 0.2 | PTFE2 | 0.5 | 0.1 | AltSt | 1 | | | 13000 | 15500 | 77¹ |
| | | | ETHYLENEBISOLEAMIDE | | | | | | | | | | | |
| E95 | A | A | N,N′- | 0.2 | PTFE2 | 0.5 | 0.1 | AltSt | 1 | | | 14500 | 15000 | 75¹ |
| | | | ETHYLENEBISOLEAMIDE | | | | | | | | | | | |
| E98 | A | A | N,N′- | 0.2 | | | | AltSt | 0.8 | NaSt | 0.5 | 13000 | 13500 | 74¹ |
| | | | ETHYLENEBISOLEAMIDE | | | | | | | | | | | |
| C-K1A | | K | | | | | | ZnSt | 0.5 | | | 10 | 140 | 88 |
| C-K1B | | K | | | | | | CaSt | 0.5 | | | 40 | >250 | 86 |
| C-K42 | B | K | Licowax PE520 | 0.5 | | | | ZnSt | 0.5 | | | 10 | 20 | 87 |
| C-K45 | B | K | Erucamide | 1 | PTFE3 | 1 | 0.5 | ZnSt | 0.7 | | | 20 | 60 | 88 |
| E-K51 | B | K | | | | | | AldiSt | 0.8 | | | 6000 | >6000 | 85 |
| E-K61 | B | K | Licowax S-FL | 0.3 | | | | AldiSt | 0.6 | St | 0.5 | 2700 | >5000 | 84 |
| E-K62 | B | K | | | PTFE3 | 0.5 | 0.25 | AldiSt | 0.6 | St | 0.5 | 7800 | >10000 | 84 |
| E-K63 | B | K | Licowax S-FL | 0.3 | ¹ | | | | | St | 0.7 | 3700 | >6000 | 86 |

¹No appreciable squeak noise by the time the experiment was stopped; time that was stopped and dB(A) at the time are reported in last 2 columns

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A copolyetherester composition comprising:
(1) at least one copolyetherester resin; and
(2) a stearate selected from:
(2b) stearic acid;
(2c) aluminium tristearate;
(2d) aluminium distearate;
(2e) mixtures of aluminium tristearate and aluminium distearate;
(2f) mixtures of two or more of any of the foregoing; and
(2g) mixtures of two or more of any of the foregoing with stearic acid or sodium stearate.

2. The copolyetherester composition of claim 1, wherein the at least one copolyetherester resin is selected from those from those prepared from the monomers (1) a poly(alkylene oxide)diol, (2) a dicarboxylic acid selected from terephthalate, isophthalate and mixtures thereof, (3) a diol selected from butane diol, propane diol and mixtures thereof.

3. The copolyetherester composition of claim 2, wherein the poly(alkylene oxide)diol is PTMEG, the dicarboxylic acid is terephthalate and the diol is 1,4-butane diol.

4. The copolyetherester composition of claim 2, wherein the copolyetherester resin comprises 35 wt % to 50 wt % of soft segments derived from the poly(alkylene oxide)diol, wherein the weight percentages are based on the total weight of the copolyetherester resin.

5. (canceled)

6. (canceled)

7. The copolyetherester composition of claim 1, wherein the stearate is selected from:
(1) aluminium tristearate at 0.5 to 1 wt %, plus sodium stearate at 0.25 to 0.75 wt %;
(2) aluminium distearate at 0.5 to 1 wt %;
(3) stearic acid at 0.3 to 0.8 wt %;
(4) aluminium distearate at 0.5 to 1 wt % plus sodium stearate at 0.25 to 0.75 wt %; and
(5) aluminium distearate at 0.5 to 1 wt % plus stearic acid at 0.25 to 0.75 wt %;
wherein the weight percentages based on the total weight of the composition.

8. The copolyetherester composition of claim 1, further comprising a wax selected from compounds with unsaturated fatty acids, such as unsaturated amides, erucamide, compounds with saturated fatty acids, polyethylene based non-polar waxes, esters of montanic acid, glycols, and combinations of two or more of these.

9. (canceled)

10. The copolyetherester composition of claim 8, wherein the wax is selected from acid waxes, erucamide, PTMEG with a molecular weight between 800 and 3,000 Da, and N,N′-ethylenebisoleamide.

11. A copolyetherester composition comprising:
(1) at least one copolyetherester resin;
(2) a stearate selected from:
(2a) sodium stearate;
(2b) stearic acid;
(2c) aluminium tristearate;
(2d) aluminium distearate;
(2e) mixtures of aluminium tristearate and aluminium distearate; and
(2f) mixtures of two or more of any of the foregoing; and
(3) polytetrafluoroethylene.

12. The copolyetherester composition of claim 11, wherein the at least one copolyetherester resin is selected from those from those prepared from the monomers (1) a poly(alkylene oxide)diol, (2) a dicarboxylic acid selected from terephthalate, isophthalate and mixtures thereof, (3) a diol selected from butane diol, propane diol and mixtures thereof.

13. The copolyetherester composition of claim 12, wherein the poly(alkylene oxide)diol is PTMEG, the dicarboxylic acid is terephthalate and the diol is 1,4-butane diol.

14. The copolyetherester composition of claim 12, wherein the copolyetherester resin comprises 35 wt % to 50 wt % of soft segments derived from the poly(alkylene oxide)diol, wherein the weight percentages are based on the total weight of the copolyetherester resin.

15. (canceled)

16. The copolyetherester composition of claim 11, wherein the stearate is selected from:
(1) aluminium distearate at 0.5 to 1.5 wt %, more preferably 1 wt %;
(2) aluminium tristearate at 0.5 to 1.5 wt %, more preferably 1 wt %;
(3) aluminium distearate at 0.4 to 1 wt %, more preferably 0.6 wt % plus stearic acid at 0.3 to 1 wt %, more preferably 0.5 wt %;
(4) aluminium distearate at 0.5 to 1 wt %, preferably 0.6 wt % plus sodium stearate at 0.4 to 1 wt %, preferably 0.8 wt %; and
(5) aluminium tristearate at 0.3 to 1 wt %, preferably 0.5 wt % plus sodium stearate at 0.3 to 1 wt %, preferably 0.5 wt %; and
(6) sodium stearate at 0.2 to 0.6 wt %;
wherein the weight percentages are based on the total weight of the composition.

17. The copolyetherester composition of claim 11, wherein the PTFE has a molecular weight of from 10⁶ to 10⁸ Da.

18. (canceled)

19. The copolyetherester composition of claim 11, wherein the PTFE is added in the form of an aqueous dispersion or PTFE encapsulated in a compatibilizing polymer.

20. The copolyetherester composition of claim 11, further comprising a wax selected from compounds with unsaturated fatty acids, such as unsaturated amides, erucamide, compounds with saturated fatty acids, polyethylene based non-polar waxes, esters of montanic acid, glycols, and combinations of two or more of these.

21. (canceled)

22. The copolyetherester composition of claim 20, wherein the wax is selected from acid waxes, erucamide, PTMEG with a molecular weight between 800 and 3,000 Da, and N,N′-ethylenebisoleamide.

23. A CVJ boot made from the copolyetherester composition of claim 1.

24. A CVJ boot made from the copolyetherester composition of claim 11.

25. The copolyetherester composition of claim 1, wherein the copolyetherester resin is present in an amount of from at or about 80 to at or about 96 weight percent; or the stearate is present in an amount of from 0.2 to 2 wt %; or the wax, if present, is present in an amount of from 0.2 to 3 wt %, based on the total weight of the copolyetherester composition.

26. The copolyetherester composition of claim 11, wherein the copolyetherester resin is present in an amount of from at or about 80 to at or about 96 weight percent; or the stearate is present in an amount of from 0.2 to 2 wt %; or the PTFE is present in an amount of from about 0.05 to 0.5 wt %; or the wax, if present, is present in an amount of from 0.2 to 3 wt %, based on the total weight of the copolyetherester composition.
